(19) United States
(12) Patent Application Publication
(10) Pub. No.: US 2004/0159412 A1
(43) Pub. Date: Aug. 19, 2004

(54) Sunshade for vehicles

(76) Inventor: Lee Austin, Rancho Santa Margarita, CA (US)

Correspondence Address: ROY A. EKSTRAND, 3158 REDHILL AVE., STE 150, COSTA MESA, CA, 92626, US

(21) Appl. No.: 10/365,920

(22) Filed: Feb. 13, 2003

(51) Int. Cl. B60J 1/20; B60J 3/00; B60J 11/00

(52) U.S. Cl. 160/370.21

(57) ABSTRACT

A sunshade for vehicles includes a plurality of segments each slidably secured to adjacent segments to form an elongated array which may be either extended to a full length, collapsed to a minimum storage length or partially extended to form an intermediate size array. Each segment is latched to its adjacent segment within the array to provide stable positioning. Each segment further supports a flexible subtle opaque shade segment which extends downwardly from its respective supporting segment. The entire array is positioned within a vehicle interior to provide an opaque shade covering the selected windows of the vehicle.

### FIELD OF THE INVENTION

This invention relates generally to vehicles and particularly to sunshade apparatus used therein.

### BACKGROUND OF THE INVENTION

Perhaps one of the most annoying problems and difficulties associated with operation of vehicles such as automobiles, sport utility vehicles, trucks or the like is found in the tendency for undesired effects upon the vehicle interior due to the invasion of sunlight. Typically, vehicles are parked for extended periods of time in exposed sunlight areas such as street parking, parking facilities or the like. The effect of sun radiating through vehicle windows to vehicle interior results in extreme overheating of the interior. This effect renders the vehicle interior extremely unpleasant and uncomfortable when the operator returns to the vehicle. In climates having extreme sunshine such as the American Southwest, the radiation of sun energy into a vehicle interior can actually render it harmful or fatal to children or pets left within a vehicle even for brief periods. In addition to the uncomfortable and unpleasant heating caused by sun radiation into vehicle interiors, the substantial energy from the sunlight passing through vehicle windows often damages materials used in the vehicle interior such as plastic, leather or the like. This in turn leads to premature aging and cracking of the vehicle interior surfaces.

Vehicle owners as well as vehicle manufacturers have attempted to reduce or minimize this problem by providing substantial tinting of vehicle windows. However, while this is benificial to some degree, the extent of tinting to be used is limited by legal requirements as well as the need for visibility by vehicle operators. Thus, extensive tinting of vehicle windows is prohibited. As the problems associated with unwanted sun energy heating of vehicle interiors and the often costly damages caused thereby continues, practitioners in the vehicle fabrication arts have provided a variety of devices intended to restrict sunlight intrusion into vehicles. While such devices are varied in structure and design, all may generally be described as a device of some type to block sun transmission through the windows of the vehicle. One type of temporary sunshade employed in vehicles is found in expandable opaque elements which are generally fabricated to be conveniently stored when not in use and to be available for extension or expansion to positions allowing them to cover the front windshield in particular. For example, U.S. Pat. No. 4,815,784 issued to Zheng sets forth an AUTOMOBILE SUNSHIELD having a generally rectangular fabric envelope within which a pair of resilient wire loop members are captivated. The loop members when fully extended maintain the rectangular fabric shade in its fully extended position for use within the interior of a vehicle windshield.

U.S. Pat. No. 4,883,304 issued to Elliott sets forth a VEHICULAR WINDOW SUNSHIELD formed of a light-weight flexible pleated panel together with three stiffening elements fixed to the right, left and center portions of the panel. The stiffening elements allow the panel to be expanded to occupy the interior of a vehicle window.

U.S. Pat. No. 4,862,943 issued to Shafia sets forth an ADJUSTABLE VEHICLE SUNSHADE which comprises a flexible shade panel and attachment means such as hooks or snaps for quick and easy installation to the inside of a vehicle window.

U.S. Pat. No. 4,861,090 issued to Gavrieli sets forth an FAN-TYPE AUTOMOBILE WINDOW SHADE having a base unit supporting a plurality of pivotally secured interlocking slats which extend to form an opaque fan within a vehicle windshield or the like.

U.S. Pat. No. 6,135,191 issued to Mitchell et al. sets forth a COLLAPSIBLE VEHICLE SUNSHADE having a flexible fabric material sheet and a center hub hingedly supporting a plurality of radially extending support members. Each of the support members is secured at its remote end to the flexible shade.

U.S. Pat. No. 6,095,230 issued to Mitchell et al. sets forth VEHICLE SUNSHADES having a shield of flexible material, a center hub and a plurality of outwardly extending flexibly hinged support members. Each support member is secured to a corner of the generally rectangular flexible sheet.

U.S. Pat. No. 5,535,808 issued to Idesis et al. sets forth a COLLAPSIBLE SUNSHADE FOR VEHICLE WINDOWS having a deformable sheet and an air bladder. The air bladder is rigid when inflated to support the sheet. A message is defined on the outer surface of the sheet material.

U.S. Pat. No. 5,660,220 issued to Ruan sets forth a PLEATED FAN TYPE SUNSHADE FOR MOTOR VEHICLES having a substantially opaque plated sheet defining a bottom end, a top end and a pair of opposite sides. The pleats having generally equal widths and are oriented substantially parallel to the sides so that the pleats fold one on top of another to collapse the sheet.

In addition to the above described prior art devices directed primarily at shading the windshield of the host vehicle, a number of prior art devices have been provided which are generally intended to shade the side windows of a vehicle. For example, U.S. Pat. No. 5,730,484 issued to Robinson sets forth an ADJUSTABLE AUTOMOBILE SHADE having a flexible opaque sheet supported by a support member configured to be received upon the visor of a vehicle. The visor is typically pivoted to its side position allowing the opaque sheet to shade the side window.

U.S. Pat. No. 4,932,711 issued to Goebel sets forth an AUTOMOBILE WINDSHIELD SHADE having an attachment tube secured to the dashboard of a vehicle. The bottom of an accordion pleated shade is attached to the base while a strip of pliant fabric is attached to the top of the shade. A hook secured above the window is coupled to the pliant fabric to allow the accordion pleated material to be raised and lowered.

U.S. Pat. No. 5,067,765 issued to Frye et al. sets forth a FLEXIBLE SUN VISOR WITH OVER CENTER SPRING having a flexible sun shading membrane defining an edge coupled to a window frame and an opposite edge attached to a movable member. The moveable member defines at least two stable positions one being closed adjacent to and conforming to the window frame and a second position extending and lowered from the window frame to stretch the membrane into a sun blocking position.

U.S. Pat. No. 5,184,659 issued to Alcocer sets forth a SUN RESISTANT FOLDABLE WINDOW SHADE for airplane windows which includes metallic thermal expansion control strips secured to either the inside or outside faces of the pleats to prevent wrinkling due to prolonged exposure to sunlight.

U.S. Pat. No. 5,207,258 issued to Lennard sets forth a LOUVERED SUNSHADE WITH CONTROLLABLE APERTURES having one or more panels for vehicle windows. The panels each define dye cuts which provide a plurality of louvered apertures.

U.S. Pat. No. 4,828,319 issued to Benson sets forth a VEHICULAR SUNSHIELD having a spring biased roll for securing a quantity of shade material proximate a window. Additional types of vehicle sunshade which are operative external to the vehicle are set forth in U.S. Pat. 6,223,760 issued to Hughey; U.S. Pat. No. 6,206,451 issued to Maano; U.S. Pat. No. 5,762,393 issued to Darmas, Sr. and U.S. Published application Ser. No. 2002/0033616 filed by Schlecht et al.

U.S. Pat. No. 5,673,742 issued to Gabb; U.S. Pat. No. 5,685,354 issued to Kim; U.S. Published patent application Ser. No. 2001/0009179 filed by Huang; U.S. Pat. No. 6,086,133 issued to Alonso; U.S. Pat. No. 6,116,256 issued to Pawsy et al; U.S. Pat. No. 6,135,193 issued to Lloyd; U.S. Pat. No. 6,192,967 issued to Huang; U.S. Pat. No. 6,345,857 issued to Leary; U.S. Pat. No. 5,114,204 issued to Bernardo; and U.S. Pat. No. 5,782,284 issued to Leatherman set forth various examples of vehicle shades generally related to the present invention.

While the foregoing described prior art devices have provided some improvement in the art and have in some instances enjoyed commercial success, there remains nonetheless a continuing need in the art for evermore improved, cost effective and efficient sunshades for vehicles.

### SUMMARY OF THE INVENTION

Accordingly, it is a general object of the present invention to provide an improved sunshade for vehicles. It is a more particular object of the present invention to provide an improved sunshade for vehicles which effectively shades the side window portions as well as windshield and rear windshield portions of a vehicle.

In accordance with the present invention there is provided a sunshade for use in a vehicle interior, the sunshade comprising: a plurality of segments slidably engaged to form an elongated array which may be extended to a maximum extension, partially collapsed to intermediate extensions or collapsed to a collapsed configuration; a plurality of flexible planar shade segments each supported by one of the segments; and a plurality of latches supported by the segments to latch each adjacent segment within the plurality of segments.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a side elevation view of a sunshade for vehicles positioned within a typical host vehicle;

FIG. 2 sets forth a partial perspective view of a segment of the present invention sunshade for vehicles;

FIG. 3 sets forth a partially sectioned side elevation view of the support mechanism of the present invention sunshade for vehicle;

FIG. 4 sets forth a section view of the present invention sunshade for vehicles taken along section lines 4-4 in FIG. 3;

FIG. 5 sets forth a perspective view of an alternate embodiment of the present invention sunshade for vehicles showing an alternative shade retainer;

FIG. 6 sets forth a partial perspective view of a further alternate embodiment of the present invention sunshade for vehicles showing an additional alternative shade retainer in its open position;

FIG. 7 sets forth a perspective view of the shade retainer of FIG. 6 in its closed position;

FIG. 8 sets forth a partial perspective view of a still further alternative shade retainer;

FIG. 9 sets forth a partial perspective view of an alternative segment latch mechanism; and

FIG. 10 sets forth a partial perspective view of a further alternative segment latch mechanism.

### DESCRIPTION OF THE PREFERRED EMBODIMENT

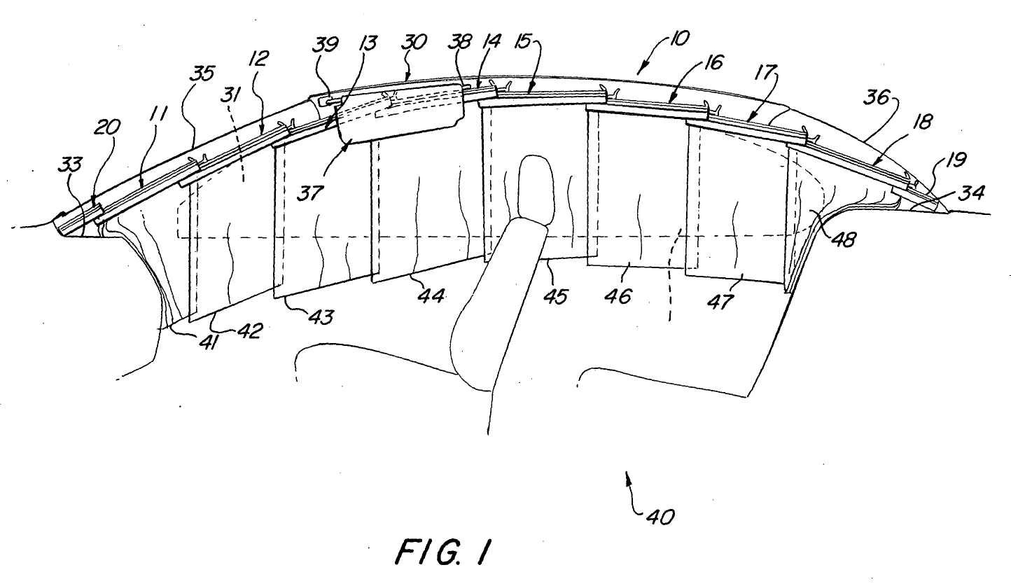

FIG. 1 sets forth a side elevation view of a sunshade for vehicles constructed in accordance with the present invention and generally referenced by numeral 10. Sunshade 10 described below in great detail is shown positioned within a host vehicle envirorrnent in accordance with a typical anticipated use of sunshade 10. The host vehicle generally referenced by numeral 40 is shown in partial section and highly simplified interior view to facilitate the maximum disclosure and description the present invention sunshade. It will be apparent to those skilled in the art that vehicle 40 is merely representative of a host vehicle and that the shape and configuration of vehicle 40 is not in any respect a limitation of the applicability of the present invention sunshade. On the contrary, it will be apparent to those skilled in the art from the descriptions that follow that the present invention sunshade readily accommodates a variety of interior configurations of vehicles including, but not limited to, conventional sedan and coupe automobiles, station wagons, sport utility vehicles as well as pick up trucks or the like. It will be further apparent to those skilled in the art that the present invention is not limited to the number of sunshade segments utilized in the example shown in FIG. 1. Once again, on the contrary, it will be apparent that in accordance with an important aspect of the present invention that a variable number of sunshade segments may be used to accommodate the above-mentioned variety of vehicle interiors and the corresponding spans of interior space required to perform the sunshade function.

More specifically, with respect to vehicle 40, a general interior is depicted having a dash board 33 and a rear deck 34 and a space between which accommodates a pair of automobile seats. Vehicle 40 also includes a front windshield 35, a vehicle roof 30 and a rear window 36. In further accordance with conventional fabrication techniques, vehicle 40 includes a movable sun visor 37 supported a rod 38 which in turn is pivotally secured to the interior of vehicle 40 by a pivot 39.

In accordance with the present invention, sunshade 10 is fabricated of a plurality of segments 11 through 18 together with end segments 19 and 20. Sunshade 10 further includes a corresponding plurality of shade segments 41 through 48 secured to segments 11 through 18 respectively. As can be seen in FIG. 1, shade segments 41 through 48 hang downwardly from their respective supporting segments of sunshade 10 and are arranged to slightly overlap each adjacent segment in the array. For example, shade segment 42 slightly overlaps shade segment 41 and in turn is slightly overlapped by adjacent segment 43 and so on. Of further interest, is the conforming character of segments 41 and 48 to the surface of dashboard 33 and rear deck 34 respectively. In the preferred fabrication of the present invention, the material from which shade segments 41 through 48 are fabricated is a relatively light-weight subtle and flexible material such as cloth or the like. This subtle flexible character of the shade segments allows each shade segment to conform loosely to the underlying and proximate surfaces of vehicle 40. In this manner, a relatively tight opaque seal is formed by shade segment 41 against dashboard 33 despite its irregular shape. Correspondingly, the flexible subtle character of shade segment 48 allows the shade segment to conform generally to the irregular surface of rear deck 34 and the rear seat of vehicle 40.

End segments 19 and 20 provide support upon the surface of rear deck 34 and dashboard 33 respectively. However, in addition and in accordance with the preferred use of the present invention sunshade, the convenient availability of sun visor 37 within vehicle 40 is utilized in providing further support for sunshade 10. Thus, as can be seen in FIG. 1, the stability of positioning for sunshade 10 when used in this position is supplemented by turning visor 37 downwardly upon rod 38 and thereafter pivoting sun visor 37 from its normal position along the upper edge of windshield 35 to the rearward extending shown in FIG. 1. When so positioned, sun visor 37 maintains sunshade 10 against the surfaces near side windows 31 and 32 of vehicle 40. This in turn ensures that shade segments 41 through 48 are positioned against side windows 31 and 32 to maximize the effectiveness of sunshade 10.

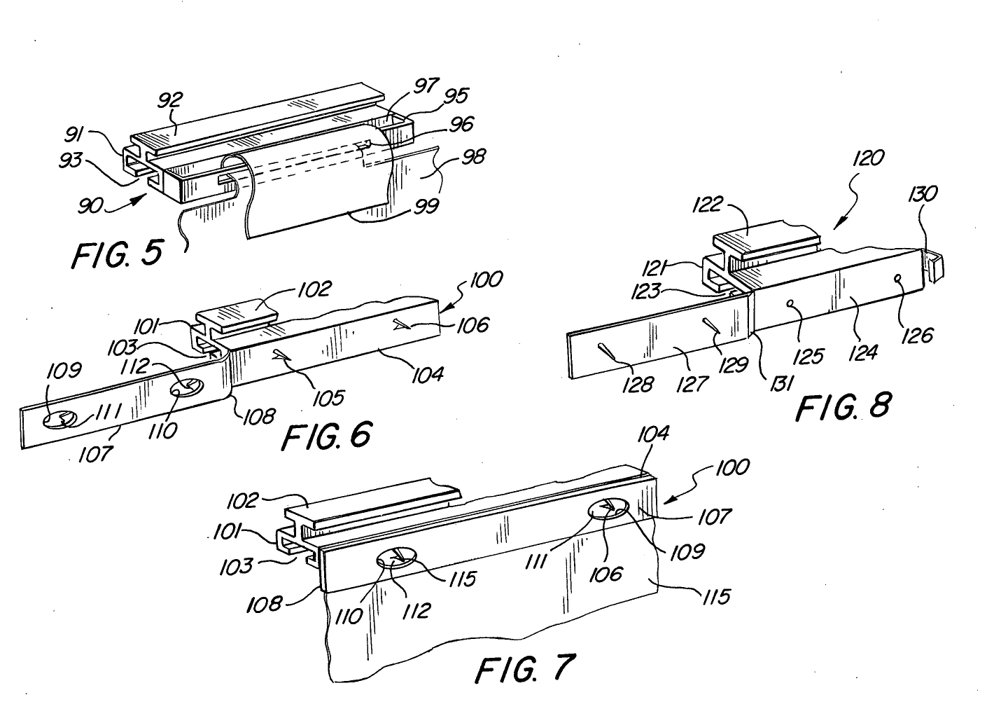

It will be apparent to those skilled in the art from the descriptions and Figures below that sunshade 10 is conveniently collapsible from the extended configuration shown in FIG. 1 to a small compact retracted configuration which facilitates convenient storage and transport of the sunshade. It will be further apparent to those skilled in the art from the examination of FIG. 1, that a variety of interlocking or slidable segment configurations may be utilized in place of segments 11 through 18 together with end segments 19 and 20 to provide support for shade segments 41 through 48 such as those set forth below in FIGS. 5 through 10.

In accordance with the present invention and by means set forth below in greater detail, the user upon entering vehicle 40 simply returns visor 37 to its normal position and moves segments 11 through 20 to their respective retracted configurations to remove sunshade 10 from side windows 31 and 32 and thereafter conveniently store the compact retracted configuration of sunshade 10.

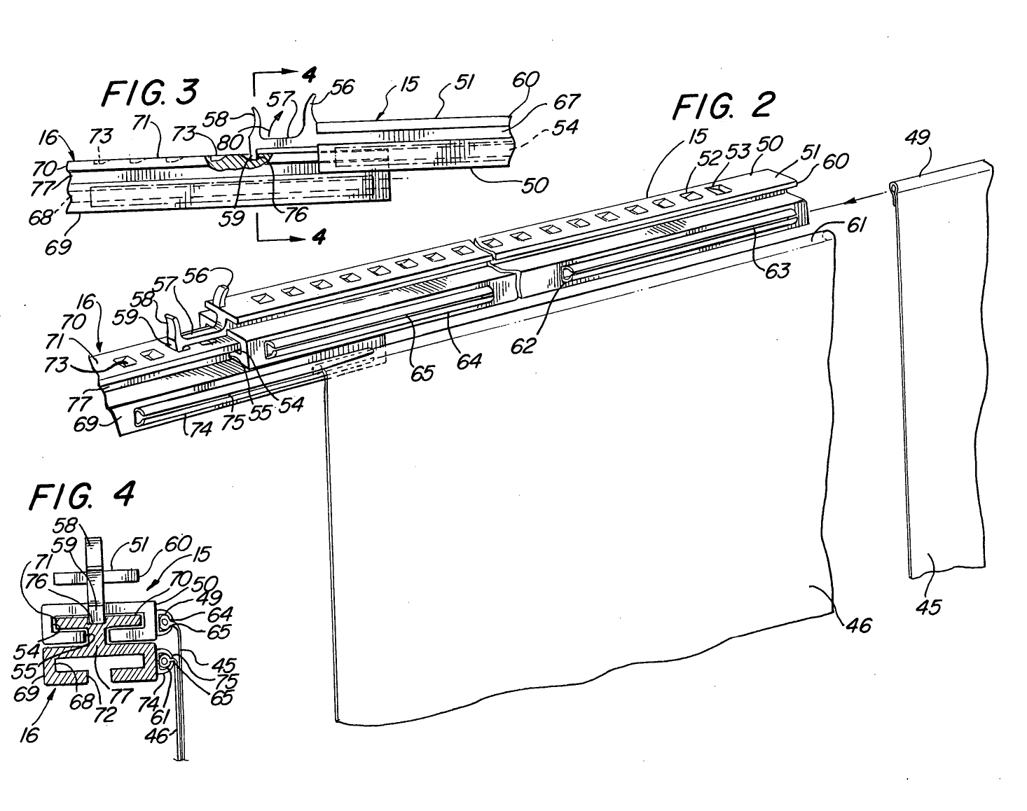

FIG. 2 sets forth a perspective view of segment 15 of sunshade 10 together with a portion of adjacent segment 16. It will be noted that segments 15 and 16 are shown oppositely oriented in FIG. 2 from their orientation in FIG. 1. Accordingly, it will be apparent to those skilled in the art that the entire segment array of sunshade 10 shown in FIG. 1 may be completely reversed with segment 20 being positioned upon rear deck 34 and segment 19 being positioned upon dashboard 33 without departing from the spirit and scope of the present invention. It will be further noted by way of overview that the structure of segment 15 is identical to the structures of segments 11 through 14 and 16 through 18 shown in FIG. 1. Thus, the descriptions of segment 15 of sunshade 10 set forth and discussed in connection with FIG. 2 are understood to apply equally well to the remaining segments 11 through 14 and 16 thorough 18 of the present invention sunshade for vehicles.

More specifically, segment 15 is preferably molded of a molded plastic material or the like and includes an upper flange 60 defining a generally planar upper surface 51. Surface 51 defines a plurality of angular facet notches 52 arranged in a generally regular spacing upon surface 51. Flange 60 further defines an end notch 53 which is oppositely oriented with respect to notches 52 and provides a travel limit upon the adjacent segment (segment 14 seen in FIG. 1) by means better seen in FIG. 3. Segment 15 further defines a body 50 which includes and supports flange 60 together with an interior channel 54 which in turn defines a downwardly facing slot 55. Body 50 further supports a pair of shade retainers 62 and 64 on a common side of body 50. Shade retainers 62 and 64 in turn define elongated slots 63 and 65 therethrough.

In further accordance with the present invention, segment 15 supports a shade segment 45 which, as described above, is preferably formed of a subtle flexible material such as cloth or the like. A cooperating bead 49 is formed along the upper edge of shade segment 45. Bead 49 is received within shade retainer 62 and 64 of segment 15 in a sliding action. As bead 49 is slide into and through retainers 62 and 64, the remainder of shade segment 45 extends outwardly through slots 63 and 65 respectively. This attachment allows shade segment 45 to be freely supported from bead 49 and allows freedom of movement of shade segment 45.

The structure of segment 15 is completed by an upwardly extending grip 56 together with a laterally extending latch arm 57. Arm 57 terminates in an upwardly extending grip 58 and a downwardly extending tooth 59 (better seen in FIG. 3). In a preferred fabrication of present invention, latch arm 57 is integrally molded with body 50 of segment 15 and is formed of a somewhat resilient plastic material. This resilience allows the user to grasp grips 56 and 58 and upon squeezing them together flex grip 58 and tooth 59 together with latch arm 57 upwardly thereby moving tooth 59 to a raised or withdrawn position. In its natural state, that is in the absence of any force exerted by the user, latch arm 57 extends laterally as shown in FIG. 2 positioning tooth 59 within any underlying notch such as notch 73 shown in adjacent segment 16.

Segment 16 is fabricated in an identical manner to segment 15 and thus includes a body 69 identical to body 50 and formed of an identical molded plastic material or the like. Body 59 defines an upper flange 70 having a generally planar upper surface 71. Surface 71 further defines a plurality of notches 73 together with an end notch 76 (seen in FIG. 3). Body 69 further supports a shade retainer 74 defining an elongated slot 75. While not seen in FIG. 2, it will be understood that body 69 of segment 16 further supports a second shade retainer in the same manner as segment 15 supports shade retainer 64.

As is better seen in FIG. 4, flange 70 of segment 16 is received within channel 54 of segment 15 in a sliding engagement. This sliding engagement is facilitated by the extension of web 77 of segment 16 downwardly through slot 55 of segment 15. This extension is better seen in section view of FIG. 4. However, suffice it to note here that the engagement between segments 15 and 16 is maintained by the insertion of flange 70 of segment 16 into channel 54 of segment 15.

In further accordance with the present invention, the extent of insertion of segment 16 into segment 15 at any selected position is maintained by the insertion of tooth 59 of latch arm 57 into a selected one of notches 73 formed in segment 15. As illustrated in FIG. 3 and with temporary reference thereto, the maximum extension of segment 16 with respect to segment 15 is latched by the insertion of tooth 59 of latch arm 57 into end notch 76 of segment 16. Alternative embodiments shown in FIGS. 5 through 10 below illustrate other methods and structures.

In operation, with each segment in the array forming sunshade 10 (seen in FIG. 1) having their respective shade segments secured thereto using their respective shade retainers such as shade segment 45 being supported within retainers 62 and 64 of segment 15, the extension of each segment with respect to its adjacent segment is determined by the sliding position of each adjacent segment. The selected extension is maintained by the latching operation of tooth 59 of latch arm 57 within a selected one of notches 73 of segment 16 and a similar cooperating latch operative between each adjacent segment pair. Thus, it will be noted that the extension or overall length of the present invention sunshade may be configured as need within the host vehicle. The angled facet of the notches such as notches 52 within segment 15 and notches 73 within segment 16 facilitates a simple extension by drawing one segment out from another. As each angled facet is forced against the latching mechanism such as tooth 59 of latch arm 57 of segment 15, the flexible character of the supporting latch arm allows the tooth to be driven upwardly along the angled facet and outwardly from the notch. Thus, as each segment is withdrawn from its cooperating adjacent segment the angled facet notches and resilient latch mechanisms allow the extension to be carried forward in a simple detented drawing movement.

When the user chooses to collapse or shorten the array, the user simply grips the latch grips and squeezes them together to withdraw the latching tooth from its underlying notches in the cooperating adjacent segment. For example, in FIG. 2, segments 15 and 16 may be collapsed together by simply squeezing grips 56 and 58 inwardly flexing latch arm 57 upwardly and withdrawing tooth 59 from notches 73 of segment 15. Once tooth 59 is withdrawn from its cooperating notches in segment 16, segment 16 may be freely collapsed into segment 15.

FIG. 3 sets forth a partial section view of the latching mechanism operative between segments 15 and 16. By way of overview, FIG. 3 shows segment 16 withdrawn to its maximum extension length with respect to segment 15. Accordingly, the latch mechanism of segment 15 is engaged within the end notch (notch 76) of segment 16.

More specifically, segment 15 includes a body 50 having an upper flange 60 defining a generally planar surface 51. As is better seen in FIG. 2, surface 51 defines an end notch 53 and a plurality of notches 52. Segment 15 further includes a web 67 extending downwardly from flange 60 of body 50. Body 50 further defines an internal channel 54 which, as is better seen in FIG. 2, further defines a slot 55 extending downwardly therethrough. Segment 15 further includes a latch arm 57 extending from web 67 and flange 60 and terminating in an upwardly extending grip 58 and a downwardly extending tooth 59. Body 50 further defines an upwardly extending grip 56. Grips 56 and 58 cooperate as the user grasps grips 56 and 58 squeezing inwardly and flexing latch arm 57 upwardly in the direction indicated by arrow 80 to release the segment latch of segment 15 engaging segment 16. Correspondingly, the release of grips 56 and 58 allows latch arm 57 to assume its relaxed or normal position shown in FIG. 3 in which tooth 59 may be received within an underlying one of the plurality of notches formed in segment 16.

As described above, segment 16 includes a body 69 having a flange 70 defining an upper surface 71 supported by a web 77. Body 69 further defines an internal channel 68 which, in an identical structure to segment 15, forms a slot corresponding to slot 55 therein. The plurality of notches 73 formed in surface 71 of segment 16 are positioned beneath the travel of latch arm 57 and tooth 59 to provide correct alignment for engagement therebetween. In the position shown in FIG. 3, segment 16 has been extended outwardly from segment 15 the maximum distance. This maximum travel limit is provided by the reverse position of end notch 76 relative to notches 73. It will be noted that unlike notches 73 which facilitate the camming of tooth 59 outwardly from each notch as segment 16 is withdrawn from segment 15, the reveres position of end notch 76 inhibits the further withdraw of segment 16 from segment 15. Thus, in order to completely remove segment 16, the user must intentionally release the latch of tooth 59 within end notch 76 by the above described gripping and squeezing process to flex latch arm 57 upwardly. Similarly, the collapse of segment 16 into segment 15 requires a squeezing of grips 56 and 58 to again flex latch arm 57 in the direction indicated by arrow 80 and allow segment 16 to be slidably moved into segment 15.

FIG. 4 sets forth a section view of segments 15 and 16 taken along section lines 4-4 in FIG. 3. As described above, segment 15 includes a body 50 defining an internal channel 54 and a downwardly extending slot 55. As is also described above, body 50 supports a flange 60 having an upper surface 51 together with a grip 58 and tooth 59 supported by latch arm 57 (seen in FIG. 3). A shade retainer 64 supported along body 50 of segment 15 defines a slot 65. A shade segment 45 includes a bead 49 received within shade retainer 64. The flexible supple material of shade segment 45 extends outwardly from bead 49 and retainer 64 through slot 65 to hang downwardly in a loose flexible manner.

Segment 16 includes a body 69 defining an internal channel 68 having a downwardly facing slot 72 formed therein. Body 69 of segment 16 further includes an upwardly extending web 77 which passed through slot 55 of segment 15 to support a flange 70. Flange 70 is slidably received within internal channel 54 of segment 15. As described above, flange 70 defines an upper surface 71 within which a plurality of notches 73 together with an end notch 76 are formed. A shade retainer 74 receives bead 61 of shade segment 46 and defines a slot 65. With bead 61 received within shade retainer 74, the remainder of shade segment 46 extends outwardly through slot 75 allowing shade segment 46 to hang downwardly in a loose support.

It will be apparent to those skilled in the art that segment 16 in turn receives the corresponding flange of segment 17 in the array set forth above in FIG. 1 and so on throughout the entire array. It will be equally apparent that flange 60 of segment 15 is correspondingly received within the internal channel of segment 14 in the above described array shown in FIG. 1 and so on to complete the linier arrangement of segments.

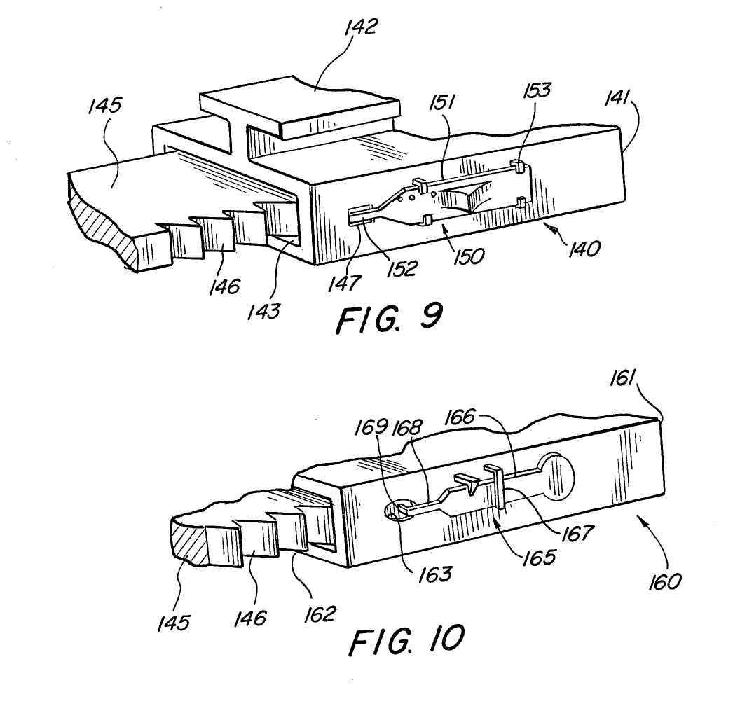

FIGS. 5 through 10 set forth partial views of alternative embodiments of the present invention sunshade for vehicles. While the various alternative embodiments set forth in FIGS. 5 through 10 define specific alternative structures for portions of the present invention sunshade for vehicles, all will be understood to operate in substantially the same collective manner as the embodiment set forth above in great detail in FIGS. 1 through 4. Thus, each of the segments shown in FIGS. 5 through 10 will be understood to include the flange and channel structures set forth above in general use for sliding engagement to form the support structure for the plurality of shade segments in the manner shown in FIG. 1. Thus, for example, FIG. 5 sets forth an alternative apparatus for securing a shade segment to a segment of the vehicle sunshade. Similarly, FIGS. 6 and 7 show a further alternate embodiment while FIG. 8 shows a still further alternate embodiment all directed toward different apparatus for securing the shade segment to the segment of the sunshade for vehicles. Further, FIGS. 9 and 10 set forth alternative structures which may be used in place of the latch arm mechanism utilized for securing the relative positions of segments in the manner shown in FIG. 2 above for the embodiment set forth in FIGS. 1 through 4. In other respects, however, it will be understood that the basic operation of the alternative embodiment set forth below in FIGS. 5 through 10 corresponds to the collective operation set forth above in FIGS. 1 through 4. Accordingly, the detailed structure which corresponds to the apparatus shown in the embodiment set forth in FIGS. 1 through 4 is not repeated in FIGS. 1 through 10.

More specifically, FIG. 5 sets forth a perspective view of a vehicle sunshade segment 90 having a body 91 defining an upper flange 92 and a lower channel 93. Segment 90 includes a shade retainer 95 having an upper opening 97 and a side slot 96 formed therein. A cooperating shade segment 98 includes a flexible tab 99 which extends upwardly through slot 96 and returns downwardly via shade retainer 95. Tab 99 may be secured to shade retainer 98 using convenient attachment such as hook and loop fasteners or conventional snap fasteners (not shown). The important aspect in the embodiment of FIG. 5 is the ability to provide alternative means of attaching shade segment 98 to sunshade segment 90.

FIGS. 6 and 7 set forth perspective views of a further alternate embodiment of the present invention sunshade for vehicles. The embodiment shown in FIGS. 6 and 7 utilizes a still further alternate apparatus for securing the sunshade segment to the body of the vehicle sunshade segment. FIG. 6 shows the shade retainer in its open position while FIG. 7 shows the closed position.

More specifically, a vehicle sunshade segment 100 includes a body 101 supporting a flange 102 and defining a lower channel 103. Body 101 further defines a retainer face 104 supporting outwardly extending hooked projections 105 and 106. A hinge 108 resiliently supports a retaining flap 107 which in turn defines a pair of elongated apertures 109 and 110. A clasp mechanism 111 is formed within aperture 109 while a similar clasp mechanism 112 is formed within aperture 110.

In the open configuration shown, flap 107 is pivoted about hinge 108 to an open position exposing retainer face 104. Also exposed are hooked projections 105 and 106. In the anticipated use of the retainer of FIG. 6, a portion of a shade segment is positioned against retainer face 104 allowing projections 105 and 106 to pierce the shade segment. Thereafter, retainer flap 107 is pivoted about hinge 108 to overlie retainer face 104 and captivate the underlying portion of the shade segment between retainer flap 107 and face 104. Projections 105 and 106 extend through apertures 110 and 109 respectively and latch to clasp portions 112 and 111 respectively to form the closed structure shown in FIG. 7.

As mentioned above, FIG. 7 shows a partial perspective view of a segment 100 which is secured to a shade segment 115 as described above.

More specifically, a vehicle sunshade segment 100 includes a body 101 supporting a flange 102 and defining a lower channel 103. Body 101 further defines a retainer face 104 supporting outwardly extending hooked projections 105 and 106. A hinge 108 resiliently supports a retaining flap 107 which in turn defines a pair of elongated apertures 109 and 110. A clasp mechanism 111 is formed within aperture 109 while a similar clasp mechanism 112 is formed within aperture 110.

FIG. 8 sets forth a partial perspective view of a still further alternate embodiment of the present invention using a shade retaining structure which is similar to the embodiment shown in FIGS. 6 and 7. Thus, a vehicle sunshade segment 120 includes an elongated body 121 having an upper flange 122 and a lower channel 123 formed therein. Body 121 further defines a face 124 having inwardly extending passages 125 and 126. A clasp mechanism 130 is secured to one end of segment 120 while a hinge 131 is secured to the opposite end. A flap 127 is secured to hinge 131 and is movable between the open position shown in FIG. 8 and a closed position in which flap 127 overlies face 124 and is secured by clasp 130. A pair of sharp projections 128 and 129 are supported upon flap 127 and, in the closed position, are received within apertures 126 and 125 respectively. The apparatus of FIG. 8 retains a captive shade segment between face 124 and flap 127 and is further secured by the piercing of projections 128 and 129.

FIG. 9 sets forth a partial perspective view of a still further alternate embodiment of the present invention sunshade for vehicles. The embodiment of FIG. 9 sets forth a sunshade vehicle segment 140 which utilizes an alternative latch mechanism for securing a cooperating segment flange 145 of an adjacent vehicle sunshade segment. More specifically, segment 140 includes a body 141 defining an upper flange 142 and a lower channel 143. Within channel 143, a segment flange 145 is slidably movable with respect to body 141 and defines a plurality of angular teeth 146. Body 141 further defines an aperture 147. A segment latch 150 includes a latch plate 11 secured by a plurality of retainers 153 and supporting a latch arm 152. Latch arm 152 extends through aperture 147 to engage teeth 146 of segment flange 145. Latch plate 151 may be slidably moved with respect to body 141 to a nonengaging position in which latch arm 152 does not extend through aperture 147 a sufficient distance to engage teeth 146. In this position, segment latch 150 is released and segment flange 145 may slide freely within body 141.

FIG. 10 sets forth a partial perspective view of a still further alternate embodiment of the present invention in which a vehicle sunshade segment 160 includes a body 161 within which a segment flange 145 having angled teeth 146 is slidably movable. Body 161 further defines an aperture 163 exposing teeth 146 within body 161. A latch plate 166 is secured to body 161 by a retainer 167. Latch plate 166 supports a resilient latch arm 168 having a tooth 169 extending through aperture 163. Tooth 169 engages angled teeth 146 of segment flange 145 to secure the position of segment flange 145 within body 161 of vehicle sunshade segment 160.

What has been shown is a sunshade for vehicles which includes a plurality of segments each identically formed and each cooperating with adjacent segments to form a sufficiently rigid array to support itself and a plurality of flexible subtle opaque shade segments to shield the vehicle interior with particular attention to the side windows thereof. The segments are collapsible to a compact storage configuration or extendable to provide maximum extension within the vehicle interior.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A sunshade for use in a vehicle interior, said sunshade comprising:
a plurality of segments slidably engaged to form an elongated array which may be extended to a maximum extension, partially collapsed to intermediate extensions or collapsed to a collapsed configuration;
a plurality of flexible planar shade segments each supported by one of said segments; and
a plurality of latches supported by said segments to latch each adjacent segment within said plurality of segments.

2. The sunshade set forth in claim 1 wherein said latches each include a latch arm supporting a tooth and one or more notches formed in said elements.

3. The sunshade set forth in claim 2 wherein said segments each include:
an internal channel for receiving a flange; and
a flange for sliding insertion into an internal channel of an adjacent one of said segments.

4. The sunshade set forth in claim 3 wherein each of said segments includes:
a slot formed in said channel for receiving a web; and
a web supporting a flange and extending through the slot formed in an adjacent one of said segments to support said flange within said internal channel.

5. The sunshade set forth in claim 4 wherein said one or more notches in each of said segments are formed in said flanges thereof.

6. The sunshade set forth in claim 5 wherein each of said segments includes a shade retainer having an elongated slot therein and wherein each of said shade segments includes a bead formed on its upper edge, said bead being received within said shade retainer such that the remainder of said shade segment passed outwardly from said elongated slot and hangs downwardly therefrom.

7. The sunshade set forth in claim 6 wherein said shade segments are formed of cloth material.
